(19) United States
(12) Patent Application Publication
(10) Pub. No.: US 2020/0210880 A1
(43) Pub. Date: Jul. 2, 2020

(54) RECONFIGURATION OF EMBEDDED SERVICES ON DEVICES USING DEVICE FUNCTIONALITY INFORMATION

(71) Applicant: SONY CORPORATION, Tokyo (JP)

(72) Inventor: JENKE WU KUO, SAN DIEGO, CA (US)

(21) Appl. No.: 16/232,134

(22) Filed: Dec. 26, 2018

(51) Int. Cl. G06N 20/00; G06N 7/00

(52) U.S. Cl. CPC G06N 20/00; H04W 84/12; G06N 7/005

(57) ABSTRACT

A system and method for reconfiguration of embedded services on devices using device functionality information, is provided. The system includes an AI-enabled device and a server. The server receives first usage information associated with the AI-enabled device and second usage information associated with a plurality of embedded AI services on the AI-enabled device. Further, the server generates an AI model based on the received first usage information and the received second usage information and discovers, from the plurality of embedded AI services, a first embedded AI service that requires a model response. The server outputs the model response using the generated AI model and reconfigures the discovered first embedded AI service based on the model response. The model response includes first functionality information and second functionality information associated with the AI-enabled device.

### CROSS-REFERENCE TO RELATED APPLICATIONS/INCORPORATION BY REFERENCE

None.

### FIELD

Various embodiments of the disclosure relate to machine learning technologies. More specifically, various embodiments of the disclosure relate to a system and a method for reconfiguration of embedded services on devices using device functionality information.

### BACKGROUND

Advancements in artificial intelligence (AI) technologies and different consumer electronic devices have paved a way to access various cloud-enabled services on different consumer electronic devices, for example, a smart television (TV). Also, developments in technologies, such as speech recognition, natural language processing, and machine learning, have made it possible to use different services that deliver different types of information (e.g., notifications) to users through different consumer electronic (CE) device, such as smart phones, smart TVs, smart cars, smart watches, and smart headphones. Typically, such services have to be pre-setup with information associated with different hardware and application level resources of the CE devices. In certain scenarios, new hardware or application level resources may become available in time with device usage. Also, availability of the hardware and software resources may vary with time. Thus, it may be difficult to keep a track of changes in such resources as the different services are pre-set to use fixed set of resources on the CE devices.

Further limitations and disadvantages of conventional and traditional approaches will become apparent to one skilled in the art, through comparison of described systems with some aspects of the present disclosure, as set forth in the remainder of the present application and with reference to the drawings.

### SUMMARY

A system and method are provided for reconfiguration of embedded services on devices using device functionality information, is provided as shown in, and/or described in connection with, at least one of the figures, as set forth more completely in the claims.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

FIG. 1 illustrates a network environment for reconfiguration of embedded services on devices using device functionality information, in accordance with an embodiment of the disclosure.

FIG. 2 illustrates a block diagram of an exemplary system for reconfiguration of embedded services on devices using device functionality information, in accordance with an embodiment of the disclosure.

FIG. 3 illustrates an exemplary scenario for implementation of the system of FIG. 2 in different stages, in accordance with an embodiment of the disclosure.

FIGS. 4A and 4B, collectively, illustrate an exemplary scenario for implementation of the system of FIG. 2, in accordance with an embodiment of the disclosure.

FIG. 5 depicts a flowchart that illustrates exemplary operations for reconfiguration of embedded services on devices using device functionality information configuration, in accordance with an embodiment of the disclosure.

### DETAILED DESCRIPTION

Certain embodiments of the disclosure may be found in a system for reconfiguration of embedded services on devices (e.g., a smartphone, a smart TV, etc.) using device functionality information. The system may include an AI-enabled device and a server. The AI-enabled device may include embedded AI services on the AI-enabled device. The system may generate an AI model that may be trained periodically (i.e. regularly) based on first usage information associated with the AI-enabled device and second usage information associated with the embedded AI services on the AI-enabled device. The first usage information may include, but are not limited to, device activity logs, physical port usage information, and network activity information. The second usage information may include, but are not limited to, operating system (OS) activity logs, application activity logs, user activity logs, and application usage pattern information. The system may be configured to discover, from the embedded AI services on the AI-enabled device, a first embedded AI service that may need to serve user-consumable information (e.g., smart notifications on TV program recommendations), based on different hardware-based or application-based functionalities of the AI-enabled device. The generated AI model may be used to output a model response. The model response may include functionality information associated with a new hardware-based functionality and a new application-based functionality of the AI-enabled device. The new hardware-based functionality or the new application-based functionality may correspond to a functionality (or device capability) that may be undiscovered or unused by embedded AI services on the AI-enabled device. The system may be further configured to reconfigure the discovered first embedded AI service based on the model response. The discovered first embedded AI service may be reconfigured to utilize the functionality information to serve the user-consumable information to the user. This may enable different embedded AI services to learn, discover new device functionalities, and customize delivery of the user-consumable information to the user. This may further enable the embedded AI services to adapt the delivery of the user-consumable information based on the device functionalities used and preferred by the user.

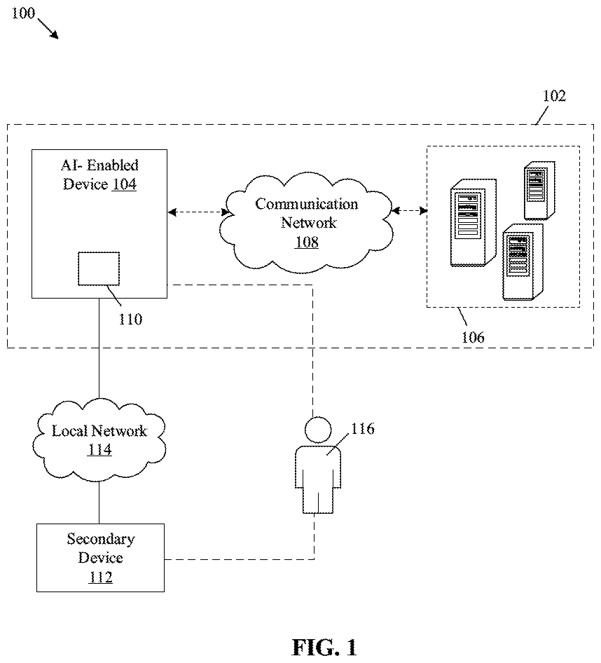

FIG. 1 illustrates a network environment for reconfiguration of embedded services on devices using device functionality information, in accordance with an embodiment of the disclosure. With reference to FIG. 1, there is shown a network environment 100. The network environment 100 includes a system 102 that includes an artificial intelligence (AI)-enabled device 104 and a server 106. The AI-enabled device 104 may be communicatively coupled to the server 106, via a communication network 108. The AI-enabled device 104 may include a plurality of embedded AI services 110. Each of the plurality of embedded AI services 110 may correspond to at least an application, circuitry, stored instructions, and/or a combination thereof on the AI-enabled device 104. Each of the plurality of embedded AI services 110 may output a type of user-consumable information, such as notifications or device control information specific to an application on the AI-enabled device 104. There is further shown a secondary device 112 that may be communicatively coupled to the AI-enabled device 104, via a local network 114. There is further shown a user 116 who may be associated with the AI-enabled device 104 and/or the secondary device 112.

The AI-enabled device 104 may comprise suitable logic, circuitry, and interfaces that may be configured to execute the plurality of embedded AI services 110 that may be configured (reconfigured or customized) with functionality information of the AI-enabled device 104 to, for example, output different types of user-consumable information. Examples of the different types of user-consumable information may include, but are not limited to, notifications, activity-based recommendations, driving routes, weather updates, media player controls, and power control options. The plurality of embedded AI services 110 may be triggered based on a user input, such as a voice input, a touch input, a gesture input, or other input types. Examples of the AI-enabled device 104 may include, but are not limited to, televisions (e.g., smart TVs or ATSC TVs), digital media players, digital cameras, gaming consoles, smartphones, laptops, desktop computers, printers, smart speakers, smart wearable electronics, and a consumer electronic (CE) device. In some embodiments, the AI-enabled device 104 may be a smart home appliance, such as a smart refrigerator, a smart washing machine, and a smart air conditioner. The AI-enabled device 104 may communicate with other AI-enabled or non-AI devices, such as the secondary device 112, via a communication network 108.

The server 106 may comprise suitable logic, circuitry, and interfaces that may be configured to generate the AI model that may be a trained machine learning (ML) model. The AI model may be generated based on the first usage information associated with the AI-enabled device 104 and second usage information associated with the plurality of embedded AI services 110 on the AI-enabled device 104. The server 106 may be further configured to output a model response that may be indicative of a new hardware-based functionality or a new application-based functionality of the AI-enabled device 104. The new hardware-based functionality or the new application-based functionality may be hardware or application level resources that may be unused or undiscovered by different embedded AI services on the AI-enabled device 104. The hardware or application level resources may be present at an installation stage of the AI-enabled device 104 or may get added with different usage activities, such as driver updates, codec updates, or new application installations, on the AI-enabled device 104. The model response may be outputted based on at least one of a user request, a device request, a request automatically initiated by an embedded AI service of the plurality of embedded AI services 110 on the AI-enabled device 104. The server 106 may be configured to operate in a service-oriented architecture. The service-oriented architecture may define a service model, for example, an Infrastructure-as-a service (IAAS), a platform-as-a-service (PAAS), a software-as-a-service (SAAS), and the like. Examples of the server 106 may include, but are not limited to, an application server, a cloud server, a web server, a database server, a file server, a gaming server, a mainframe server, or a combination thereof. In accordance with an embodiment, the functionalities and parts of operations executed by the server 106 may be implemented on the AI-enabled device 104, without a deviation from the scope of the disclosure.

The communication network 108 may comprise suitable logic, circuitry, and interfaces that may be configured to provide a plurality of network ports and a plurality of communication channels for transmission and reception of data. Each network port may correspond to a virtual address (or a physical machine address) for transmission and reception of the communication data. For example, the virtual address may be an Internet Protocol Version 4 (IPV4) (or an IPV6 address) and the physical address may be a Media Access Control (MAC) address. The communication network 108 may include a medium through which the AI-enabled device 104 and/or the server 106 may communicate with each other. The communication network 108 may be associated with an application layer for implementation of communication protocols based on one or more communication requests from at least one of the one or more communication devices. The communication data may be transmitted or received, via the communication protocols. Examples of such wired and wireless communication protocols may include, but are not limited to, Transmission Control Protocol and Internet Protocol (TCP/IP), User Datagram Protocol (UDP), Hypertext Transfer Protocol (HTTP), File Transfer Protocol (FTP), ZigBee, EDGE, infrared (IR), IEEE 802.11, 802.16, cellular communication protocols, and/or Bluetooth (BT) communication protocols.

Examples of the communication network 108 may include, but is not limited to a wireless channel, a wired channel, a combination of wireless and wired channel thereof. The wireless or wired channel may be associated with a network standard which may be defined by one of a Local Area Network (LAN), a Personal Area Network (PAN), a Wireless Local Area Network (WLAN), a Wireless Sensor Network (WSN), Wireless Area Network (WAN), Wireless Wide Area Network (WWAN), a Long Term Evolution (LTE) network, a plain old telephone service (POTS), and a Metropolitan Area Network (MAN).

The secondary device 112 may comprise suitable logic, circuitry, and interfaces that may be configured to receive a model response from the AI-enabled device 104, via the local network 114. In some embodiments, the secondary device 112 may include a set of embedded AI services that may be reconfigured on the secondary device 112 by the server 106, via an application programming interface (API). The secondary device 112 may be a personal device accessible to a user (e.g., the user 116) of the AI-enabled device 104. In certain cases, the secondary device 112 may be a device (e.g., a smart TV, a smart speaker, etc.) that may be a part of a home network of devices. Such home network of devices may also include the AI-enabled device 104 along with other devices, such as home security devices, entertainment devices, and home automation devices (e.g., smart lights, smart switches, etc.). Examples of the secondary device 112 may include, but are not limited to, a smart phone, a smart TV, wearable's like a smart watch, Virtual Reality/Augmented Reality/Mixed Reality (AR/VR/MR) headsets, and smart speakers (enabled with smart conversation agents).

The local network 114 may include a medium through which the AI-enabled device 104 and/or the secondary device 112 may communicate with each other. The local network 114 may be a wired or a wireless communication network. The availability of the local network 114 may be indicated by generation of a first model response by the server 106. In accordance with an embodiment, the AI-enabled device 104 may act as an access point (AP) of the local network 114, through which the secondary device 112 may be configured to receive data from the AI-enabled device 104 and/or the server 106. The local network 114 may include, but is not limited to, a Local Area Network (LAN), a Wireless Local Area Network (WLAN), a wireless home network (WHN), a wireless local area network (WLAN), or a wireless ad hoc network (WANET), a 2nd Generation (2G), a 3rd Generation (3G), a 4th Generation (4G) cellular, or a combination thereof. Various devices in the network environment 100 may be configured to connect to the local network 114, in accordance with various wired and wireless communication protocols. Examples of such wired and wireless communication protocols may include, but are not limited to, TCP/IP, UDP, HTTP, File Transfer Protocol FTP, Zig Bee, EDGE, infrared (IR), IEEE 802.11, 802.16, cellular communication protocols, and/or Bluetooth (BT) communication protocols.

In operation, the plurality of embedded AI services 110 may be operational on the AI-enabled device 104. As an example, an embedded AI service, such as an intelligent travel suggestion service may be operations on the AI-enabled device 104 based on hyper local weather information and a calendar schedule of the user 116. Each embedded AI service on the AI-enabled device 104 may be managed by a functional service on the server 106 (e.g., a cloud server dedicated for a type of embedded AI service). A functional service may be a cloud service that may manage the requirements (e.g. data required for an embedded AI service) and one or more operations of an embedded AI service on the AI-enabled device 104. Alternatively, the embedded AI service may be a self-managed service operational on the AI-enabled device 104. In accordance with an embodiment, the AI-enabled device 104 may interact with the functional services on the server 106 via Application Program Interfaces (APIs) to exchange data related to the plurality of embedded AI services 110. Such embedded AI services may be used for different functions, such as, to switch on the TV, to set an event on a calendar application, to make a telephone call, or to get directions for a destination. At least one of the plurality of embedded AI services 110 may utilize the computational resources of the AI-enabled device 104 to output user-consumable information (e.g., status updates, notifications, audio-video updates, personalized information etc.) to the user 116. The user consumable information may be personalized information delivered on the AI-enabled device 104 or other secondary devices associated with the AI-enabled device 104. The user consumable information may include, but are not limited to, audio content, video content, text content, image, graphics, audio-visual notifications, actionable insights, user selectable options, guidance information, visual information, audio-visual recommendations, or a combination thereof.

The AI-enabled device 104 may have different functionalities, such as hardware-based functionalities and application-based functionalities. Initially, the plurality of embedded AI services 110 may not be pre-configured to utilize the different functionalities of the AI-enabled device 104. Instead, one or more embedded AI services of the plurality of embedded AI services 110 may be updated with information associated with the different functionalities of the AI-enabled device 104. Also, such one or more embedded AI services may be reconfigured to use the different functionalities to serve the user-consumable information to the user 116.

The AI-enabled device 104 may be configured to collect first usage information associated with the AI-enabled device 104. The first usage information may include, but is not limited to, device activity logs, physical port usage information, and network activity information. As an example, the network connectivity information of the AI-enabled device 104 may include, but is not limited to, a bandwidth of the network (between the AI-enabled device 104 and the server 106), a type of network, a duration for which the AI-enabled device 104 accesses the network.

The AI-enabled device 104 may be further configured to collect second usage information associated with the plurality of embedded AI services 110. The second usage information may include, but is not limited to, operating system (OS) activity logs, application activity logs, user activity logs, and application usage pattern information. As an example, the user activity logs may include, but are not limited to, a list of music played, a food type ordered online, a user traveling time, and a list of programs watched on the AI-enabled device 104 or the secondary device 112.

The server 106 may be configured to receive the first usage information associated with the AI-enabled device 104 and the second usage information from the AI-enabled device 104, via the communication network 108. The second usage information may be received or inferred based on real time user activities on the AI-enabled device 104. The received first usage information and the second usage information may correspond to training data for an untrained or a partially trained ML model on the server 106.

The server 106 may be further configured to generate an AI model based on the received first usage information and the received second usage information. The AI model may be the trained ML model on the server 106. Also, the AI model may be a service-specific (or a service-independent) ML model developed, managed, and trained on the server 106. The generation of the AI model may correspond to the training of the untrained ML model on the training data, i.e. the first usage information and the second usage information. In some embodiments, the training of the untrained AI model may be accelerated based on an AI accelerator circuitry (e.g., an AI accelerator application-specific integrated circuit (ASIC)). The AI accelerator circuitry may be a server-end (online) AI accelerator circuitry (i.e., available on the server 106) or an on-device (offline) AI accelerator circuitry on the AI-enabled device 104. The learning rate and learning errors of the AI model may be further optimized based on specific learning optimization models, for example, heuristic or meta-heuristic optimization models, or other optimization models, such as Adagrad, Adadelta, Adamax, momentum, AMSgrad, etc.

The server 106 may be further configured to discover, from the plurality of embedded AI services 110, a first embedded AI service that may require a model response. As an example, the discovered first embedded AI service may need to be reconfigured or customized to use different functionalities, for example, a media streaming functionality or an internet upload functionality, to execute different functions, such as to generate user-consumable information on the AI-enabled device 104.

The server 106 may be further configured to output the model response using the generated AI model. The generated AI model may automatically identify patterns and/or relationships data points (as feature vectors) from the training data and discover a new hardware-based functionality or a new hardware-based functionality of the AI-enabled device 104. For example, the AI model may use a log for a voice input activity on the AI-enabled device 104 to discover presence of a microphone functionality, i.e. a hardware-based functionality, on the AI-enabled device 104. The model response may include first functionality information and second functionality information associated with the AI-enabled device 104. The first functionality information may include the new hardware-based functionality of a set of hardware-based functionalities of the AI-enabled device 104. The set of hardware-based functionalities of the AI-enabled device 104 may include, but are not limited to, an audio functionality, a video functionality, a touch screen functionality, an input/output (I/O) functionality, a gesture input functionality, a speaker functionality, a microphone functionality, and a High Definition Multimedia Interface (HDMI) functionality. The second functionality information may include a new application-based functionality of a set of application-based functionalities of the AI-enabled device 104. The set of application-based functionalities of the AI-enabled device 104 may include a media streaming functionality, a media storage functionality, an Audio/Video (A/V) codec functionality, and a local cloud caching functionality. As an example, an input/output (I/O) functionality may be inferred (or generated) based on different user activities and user inputs (e.g., user footprints based on textual inputs, searched keywords, voice inputs, touch inputs, etc.) for different embedded AI services on the AI-enabled device 104.

The AI-enabled device 104 may include a functional database (not shown in FIG. 1) that may store the model response from the server 106 for the discovered first embedded AI service on the AI-enabled device 104. The server 106 may be further configured to reconfigure the discovered first embedded AI service based on the model response. The discovered first embedded AI service may be reconfigured (i.e. customized) to utilize the new hardware-based functionality and/or the new application-based functionality of the AI-enabled device 104. For example, the model response may include a location discovery functionality, such as a Global Navigational Satellite System (GNSS) sensor. The server 106 may be configured to discover that a to-do list embedded AI service needs to use the location discovery functionality to verify a to-do item, such as a “Travel to San Diego, California”. The server 106 may be configured to reconfigure the discovered to-do list embedded AI service on the AI-enabled device 104 to enable the use of the location discovery functionality.

In accordance with an embodiment, the server 106 may be configured to reconfigure the discovered first embedded AI service to output the user-consumable information on the AI-enabled device 104. As an example, a smart travel stay recommendation service may need to identify a current route of the user's vehicle. The smart travel stay recommendation service may need to use an application-based functionality, such as “Maps”, to generate and deliver travel stay recommendations. Once the server 106 validates presence of the application-based functionality “Maps” in model response, the smart travel stay recommendation service may be reconfigured to use the application-based functionality, “Maps”.

In accordance with another embodiment, the server 106 may be configured to reconfigure the discovered first embedded AI service in response to a user input for user-consumable information on the AI-enabled device 104. The user input may be received via an input device. The input device may be an embedded input device within the AI-enabled device 104, an externally coupled input to the AI-enabled device 104, the secondary device 112, or other network interfaced or coupled input devices. Examples of the input device may include, but are not limited to, a touchscreen, a microphone, a keyboard, a mouse, a joystick, a haptic input, a gesture input device, a motion sensor, a game controller, a speaker functionality, a remote (a non-TV remote), a High Definition Multimedia Interface (HDMI) functionality and a smart TV remote. The discovered first embedded AI service may be reconfigured based on the first functionality information and/or the second functionality information in the model response.

As an example, a user input may be received to display weather information on the AI-enabled device 104. The weather information may be delivered by an embedded weather AI service on the AI-enabled device 104. The embedded weather AI service may need to use functionalities, such as network access functionality and a location access functionality. The server 106 may be configured to output the model response that includes the information related to presence of the network access functionality and/or the location access functionality on the AI-enabled device 104. The server 106 may be further configured to reconfigure the embedded weather AI service to use the network access functionality and/or the location access functionality, based on the model response.

Illustrated in FIG. 1, the AI model is generated, stored and updated on the server 106. However, in some embodiments, the AI-enabled device 104 may be configured to cache the generated AI model in a dedicated persistent or a non-persistent storage on the AI-enabled device 104. The operations associated with the cached AI model on the AI-enabled device 104 may be same as that on the server 106, without a deviation from the scope of the present disclosure.

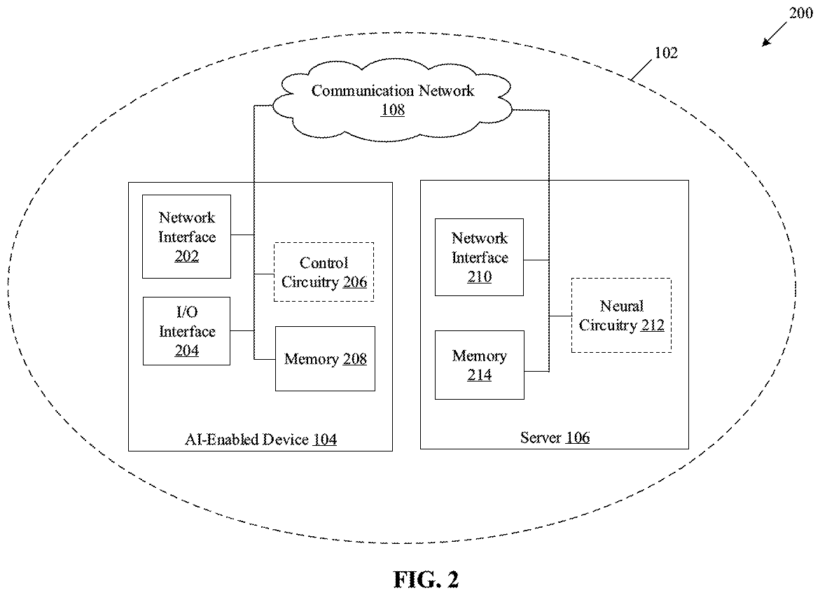

FIG. 2 illustrates a block diagram of an exemplary system for reconfiguration of embedded services on devices using device functionality information, in accordance with an embodiment of the disclosure. FIG. 2 is explained in conjunction with elements from FIG. 1. With reference to FIG. 2, there is shown a block diagram 200 of the system 102 that includes the AI-enabled device 104 and the server 106. The AI-enabled device 104 may be communicatively coupled to the server 106, via the communication network 108. The AI-enabled device 104 may include one or more circuits, such as a network interface 202, an input/output (I/O) interface 204, control circuitry 206, and a memory 208. The server 106 may include one or more circuits, such as a network interface 210, neural circuitry 212, and a memory 214.

The network interface 202 may comprise suitable logic, circuitry, and interfaces that may be configured to communicate with other systems and devices in the network environment 100, via the communication network 108 and/or and the local network 114.

The network interface 202 may be implemented by use of known technologies to support wired or wireless communication of the AI-enabled device 104 with the communication network 108 and the local network 114. Components of the network interface 202 may include, but are not limited to, an antenna, a radio frequency (RF) transceiver, one or more amplifiers, a tuner, one or more oscillators, a digital signal processor, a coder-decoder (CODEC) chipset, a subscriber identity module (SIM) card, and/or a local buffer circuit.

The I/O interface 204 may comprise suitable logic, circuitry, and interfaces that may be configured to operate as an I/O channel/interface between a user (e.g., the user 116) and different operational components of the AI-enabled device 104 or other secondary devices (e.g., the secondary device 112). The I/O interface 204 may facilitate an I/O device (for example, an I/O console) to receive a user input and present an output based on the received user input. The I/O interface 204 may include various input and output ports to connect various I/O devices that may communicate with different operational components of the AI-enabled device 104. Examples of the input devices may include, but are not limited to, a touch screen, a keyboard, a mouse, a joystick, a microphone, and an image-capture device. Examples of the output devices may include, but are not limited to, a display, a speaker, a haptic output device, or other sensory output devices.

The control circuitry 206 may comprise suitable logic, circuitry, and interfaces that may be configured to handle operations of the plurality of embedded AI services 110 on the AI-enabled device 104. The control circuitry 206 may be configured to execute instructions stored in the memory 208. Examples of the control circuitry 206 may be an

Application-Specific Integrated Circuit (ASIC) processor, a Complex Instruction Set Computing (CISC) processor, a central processing unit (CPU), a Reduced Instruction Set Computer (RISC) processor, a Graphical Processing Unit (GPU), an Explicitly Parallel Instruction Computing (EPIC) processor, a Very Long Instruction Word (VLIW) processor, and/or other processors or circuits.

The memory 208 may comprise suitable logic, circuitry, and/or interfaces that may be configured to store machine code and/or instructions executable by the control circuitry 206. The memory 208 may include a dedicated storage for a functional database and the plurality of embedded AI services 110. The functional database may store the model response from the server 106 and instructions associated with the first usage information and the second usage information. Examples of implementation of the memory 208 may include, but are not limited to, Random Access Memory (RAM), Read Only Memory (ROM), Electrically Erasable Programmable Read-Only Memory (EEPROM), Hard Disk Drive (HDD), a Solid-State Drive (SSD), a CPU cache, and/or a Secure Digital (SD) card.

The network interface 210 may comprise suitable logic, circuitry, and interfaces that may be configured to communicate with other systems and devices in the network environment 100, via the communication network 108 or and the local network 114. The network interface 210 may be implemented by use of known technologies to support wired or wireless communication of the server 106 with the communication network 108 and the local network 114. Components of the network interface 210 may include, but are not limited to, an antenna, a radio frequency (RF) transceiver, one or more amplifiers, a tuner, one or more oscillators, a digital signal processor, a coder-decoder (CODEC) chipset, a subscriber identity module (SIM) card, and/or a local buffer circuit.

The neural circuitry 212 may comprise suitable logic, circuitry, and interfaces that may be configured to generate the AI model, i.e. a trained ML model on the training data, such as the first usage information and the second usage information stored in the memory 214. The AI model may include multiple network layers, where each layer constantly adjusts its weights while learning and triggers at thresholds until the output of its final layer consistently represents a solution for an embedded AI service. The neural circuitry 212 may be implemented based on a number of processor technologies known in the art. Examples of the neural circuitry 212 may be an ASIC processor, a CISC processor, a RISC processor, a GPU, a CPU, an EPIC processor, a VLIW processor, and/or other processors or circuits. Also, in some embodiments, the neural circuitry 212 may be a specialized AI circuitry that may be implemented based on a Bayesian model, a machine learning model, or a deep learning model, such as a recurrent neural network (RNN), a convolutional neural network (CNN), and a feed-forward neural network.

The memory 214 may comprise suitable logic, circuitry, and/or interfaces that may be configured to store a machine code and/or instructions executable by the neural circuitry 212. The memory 214 may include a dedicated storage for the first usage information associated with the AI-enabled device 104 and the second usage information associated with the plurality of embedded AI services 110. Examples of implementation of the memory 214 may include, but are not limited to, Random Access Memory (RAM), Read Only Memory (ROM), Electrically Erasable Programmable Read-Only Memory (EEPROM), Hard Disk Drive (HDD), a Solid-State Drive (SSD), a CPU cache, and/or a Secure Digital (SD) card.

In operation, the plurality of embedded AI services 110 may be operational on the AI-enabled device 104. Examples of the plurality of intelligent services may include, but are not limited to, a voice input processing service, a navigation service, a media playback service, a data streaming service, a calling service, a messaging service, or a personalized device control and recommendation service. In accordance with an embodiment, the control circuitry 206 may be configured to receive a request associated with one or more of the plurality of embedded AI services 110 on the AI-enabled device 104. The request may be at least one of a user request, a device request, a request initiated by an embedded AI service, or a functional service on the server 106. For example, a user request may include a voice input, such as “What is the weather today? The voice input may be received through the I/O interface 204 of the AI-enabled device 104. The user request may be received to display event information, such as weather information, on the AI-enabled device 104.

The control circuitry 206 may be configured to collect first usage information associated with the AI-enabled device 104. The first usage information may include, but are not limited to, device activity logs (e.g., usage of microphone and speakers), physical port usage information, and network activity information. Similarly, the control circuitry 206 may be configured to collect second usage information associated with the plurality of embedded AI services 110 on the AI-enabled device 104. The second usage information may include, but are not limited to, operating system (OS) activity logs, application activity logs, user activity logs, and application usage pattern information. For example, a user may listen to jazz music daily for “1 hour” on the AI-enabled device 104, which may be logged by the control circuitry 206 as a user's act of listening to Jazz music daily in the user activity logs.

The neural circuitry 212 may be configured to generate the AI model that is trained based on the received first usage information and the second usage information. In accordance with an embodiment, the neural circuitry 212 may be configured to generate the AI model by training an untrained AI model on the first usage information and the second usage information. In accordance with an embodiment, the neural circuitry 212 may be further configured to update the AI model based on a real time or a near-real time change in the first usage information and the second usage information of the AI-enabled device 104. For example, a smart conversational agent application may be installed and used on a smart TV to access programs, change playback properties, select subtitle languages, and the like. The usage of the smart conversational agent application may be logged in specific application logs on the smart TV. The control circuitry 206 may be configured to transmit the specific application logs as an update to the server 106. On the server 106, the neural circuitry 212 may be configured to further train the AI model based on the specific application logs as an input to the AI model. This may help the AI model to discover all the functionalities associated with the usage of the smart conversational agent application on the AI-enabled device 104.

In accordance with an embodiment, the neural circuitry 212 may be further configured to determine a set of current hardware-based functionalities and a set of current application-based functionalities in use by each embedded AI service of the plurality of embedded AI services 110. The neural circuitry 212 may be further configured to discover, from the plurality of embedded AI services 110, a first embedded AI service that requires a model response to execute different functions, for example, display user-consumable message notifications, on the AI-enabled device 104. Also, in some embodiments, the neural circuitry 212 may be configured to discover the first embedded AI service that may require a configuration setting for a new hardware-based functionality or a new application-based functionality. The new hardware-based functionality or the new application-based functionality may be hardware or application level resources that may be unused or undiscovered by different embedded AI services on the AI-enabled device 104. The hardware or application level resources may be present at an installation stage of the AI-enabled device 104 or may get added with different usage activities, such as driver updates, codec updates, or new application installations, on the AI-enabled device 104.

The first embedded AI service may be discovered further based on the determined set of current hardware-based functionalities and the set of current application-based functionalities of the AI-enabled device 104. For example, an embedded AI program guide service may use a display functionality, a music tone functionality, and a network access functionality of the smart TV to notify the user 116 about programs that may be of interest to the user 116. Similarly, other embedded AI services on the smart TV may use same or different functionalities on the smart TV. A user's smartphone may store information about the user's daily activities on social media, messaging applications, or other platforms. The user's smartphone may be regularly paired with the smart TV, via an ad hoc network and the stored information on the smartphone may be synched with the smart TV. The control circuitry 206 may be configured to transmit the information as an update to the server 106. On the server 106, the neural circuitry 212 may be configured to discover that the embedded AI program guide service requires a configuration setting. The configuration setting may enable the embedded AI program guide service to access the information synched from the user's smartphone to generate targeted program notifications and/or recommendations.

The neural circuitry 212 may be further configured to output a model response using the AI model. The model response may include first functionality information and second functionality information associated with the AI-enabled device 104. The first functionality information may include the new hardware-based functionality of the set of hardware-based functionalities and the second functionality information may include the new application-based functionality of the set of application-based functionalities of the AI-enabled device 104.

In accordance with an embodiment, the neural circuitry 212 may be further configured to validate the new hardware-based functionality or the new application-based functionality of the AI-enabled device 104 by application of a self-diagnostic test scheme on the first functionality information and the second functionality information. The neural circuitry 212 may be further configured to transmit the model response to the AI-enabled device 104, based on the validation of the new hardware-based functionality or the new application-based functionality. The application of the self-diagnostic test scheme on the first functionality information and the second functionality information may correspond to the validation of presence of the new hardware-based functionality or the new application-based functionality of the AI-enabled device 104.

The neural circuitry 212 may be further configured to reconfigure the discovered first embedded AI service based on the model response. For example, the discovered first embedded AI service may be an embedded music streaming AI service on the AI-enabled device 104. It may be determined that the embedded music streaming AI service may need a speech-to-text search functionality on the AI-enabled device 104 to search for music titles on cloud music servers, based on voice inputs from the user 116. The model response from the server 106 may indicate presence of a smart conversational agent functionality that may also act as a speech-to-text search engine functionality for the AI-enabled device 104. Based on the model response, the neural circuitry 212 may be configured to reconfigure the embedded music streaming AI service to use the smart conversational agent functionality on the AI-enabled device 104 to search for the music titles on the cloud music servers.

In accordance with an embodiment, the neural circuitry 212 may be further configured to reconfigure the discovered first embedded AI service to generate user consumable information. In such case, the model response may act as supplemental information that may be required to be accessed in real time or near real time for generation and/or delivery of the user consumable information. The user consumable information may be generated to assist the user 116 to take improved decisions, actions, interact with different devices in vicinity of the AI-enabled device 104, and automate different tasks. Also, in some cases, the user consumable information may be generated to alert the user regarding an event, situation (e.g., a bad weather), or to call for an action pending for the user 116. The user consumable information may include, but are not limited to, audio content, video content, text content, image, graphics, audio-visual notifications, actionable insights, user selectable options, guidance information, visual information, audio-visual recommendations, or a combination thereof.

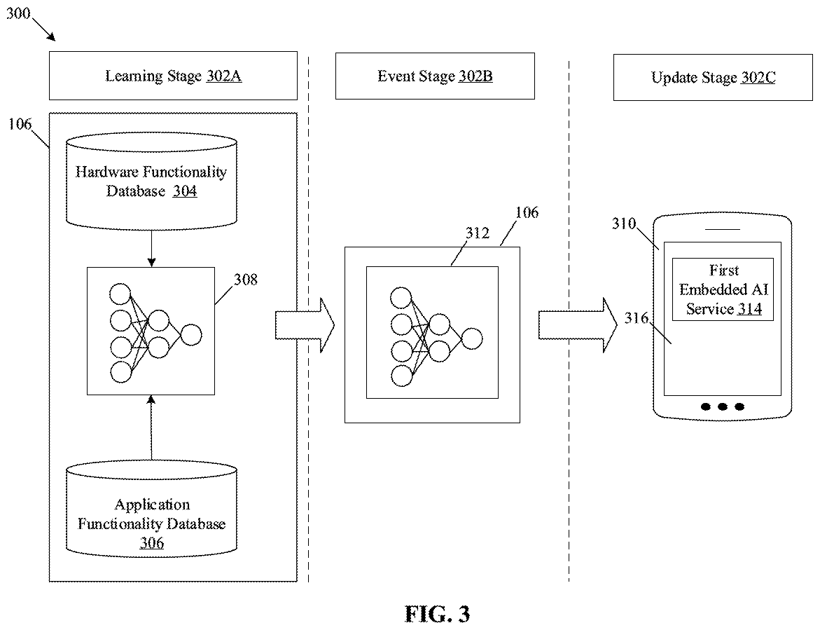

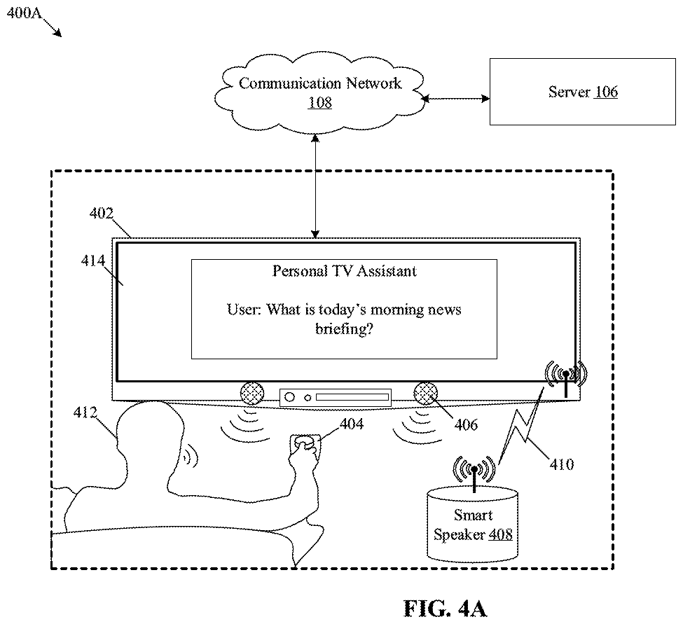

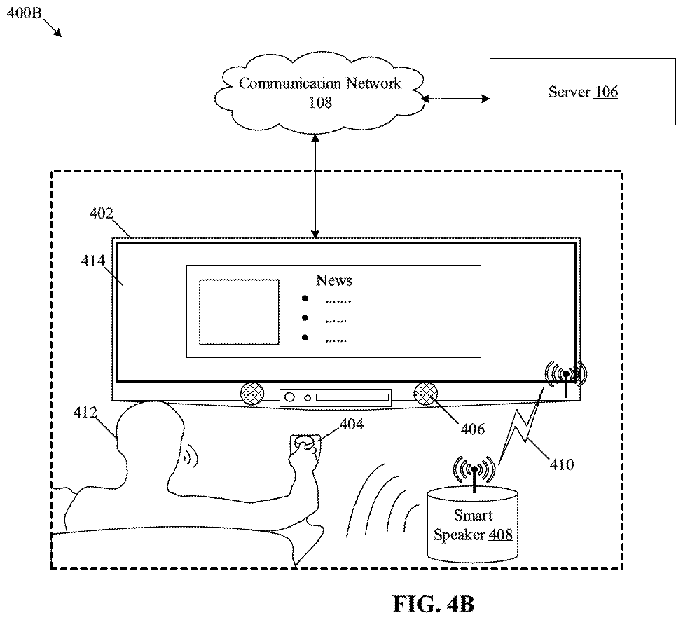

In an exemplary scenario, the system 102 may further include a set of secondary devices, such as the secondary device 112, in vicinity of the AI-enabled device 104. Each secondary device in the set of secondary devices may include a set of embedded AI services. The control circuitry 206 may be configured to generate the local network 114 between the AI-enabled device 104 and the set of secondary devices, such the secondary device 112. The local network 114 may be at least one of a wireless home network, a wireless local area network (WLAN), or a wireless ad hoc network (WANET). The AI-enabled device 104 may act as an access point (e.g., a wireless access point) for the set of secondary devices in the local network 114. The neural circuitry 212 may be configured to generate a first model response that may indicate an availability of the local network 114. The control circuitry 206 may be further configured to receive the first model response and update the plurality of embedded AI services 110 on the AI-enabled device 104 with the first model response. This may inform each of the plurality of embedded AI services 110 about the availability of the local network 114. The control circuitry 206 may be further configured to share the model response with one or more of the set of secondary devices, via the local network 114. The model response may be stored in local storage on the secondary device 112. Also, the control circuitry 206 may be configured to share a cached version of the AI model with the set of secondary devices, via the local network 114. This may facilitate a device-to-device offline transfer of AI model and/or the model response. The neural circuitry 212 may be further configured to configure, via an application programming interface (API), the set of embedded AI services on one or more of the set of secondary devices (such as the secondary device 112), based on the shared model response. The operation of the neural circuitry 212 is explained in detail, for example, in FIGS. 3, 4A, and 4B.

FIG. 3 illustrates an exemplary scenario for implementation of the system of FIG. 2 in different stages, in accordance with an embodiment of the disclosure. FIG. 3 is explained in conjunction with elements from FIGS. 1 and 2. With reference to FIG. 3, there is shown a scenario 300 that depicts different stages of operation of the system 102. The different stages may include a learning stage 302A, an event stage 302B, and an update stage 302C.

In the learning stage 302A, there is shown a hardware functionality database 304, an application functionality database 306, and an untrained AI model 308 stored in the memory 214 of the server 106. The neural circuitry 212 may be configured to receive the first usage information and the second usage information from an AI-enabled smartphone 310. The AI-enabled smartphone 310 may correspond to the AI-enabled device 104. The neural circuitry 212 may be configured to store the first usage information and the second usage information in different databases, such as the hardware functionality database 304 and the application functionality database 306.

The hardware functionality database 304 may include the first usage information, i.e. information associated with the hardware components in the AI-enabled smartphone 310 and/or the hardware devices interfaced with the AI-enabled smartphone 310. The hardware functionality database 304 may include physical port usage information, device access logs, network connectivity information at different timestamps, and information of usage durations of different device features (e.g., camera, internet, microphone, calling services, etc.).

The application functionality database 306 may include the second usage information, i.e. information associated with different embedded AI services on AI-enabled smartphone 310. For example, the application functionality database 306 may include details of user's activity on the AI-enabled smartphone 310 and with other devices, for example, a smart TV that is connected via a common network (e.g., the local network 114) to the AI-enabled smartphone 310.

In the learning stage 302A, the neural circuitry 212 may be further configured to train the untrained AI model 308 on training data, i.e. data from the hardware functionality database 304 and the application functionality database 306. For example, for a music service on the AI-enabled smartphone 310, the control circuitry 206 may collect the first usage information and the second usage information associated with the AI-enabled smartphone 310. The first usage information may include usage details of smart speakers integrated with the AI-enabled smartphone 310 and the second usage information may include usage details of audio decoders on the AI-enabled smartphone 310 to decode audio media.

In the event stage 302B, there is shown a trained AI model 312 in the memory 214 on the server 106. Alternatively, the trained AI model 312 may be cached to a local storage on the AI-enabled smartphone 310. The trained AI model 312 may correspond to the untrained AI model 308. The neural circuitry 212 may be configured to discover a first embedded AI service 314 (such as a weather service) that may have a requirement to access a new hardware-based functionality or a new application-based functionality on the AI-enabled smartphone 310. The neural circuitry 212 may be further configured to output the model response that include the first functionality information and the second functionality information, using the trained AI model 312. The first functionality information may include the new hardware-based functionality or the new application-based functionality of the AI-enabled smartphone 310.

For example, for a travel update service on the AI-enabled smartphone 310, the neural circuitry 212 may be configured to determine presence of the weather service and a navigation service from a model response of the trained AI model 312. The neural circuitry 212 may be further configured to determine a requirement of data, such as weather data and a daily travel route taken by the user 116 to travel from office to home, for the travel update service (i.e. the discovered first embedded AI service 314). The weather data may be for a region hyper local to the user 116 of the AI-enabled smartphone 310.

In the update stage 302C, there is shown a display 316 of the AI-enabled smartphone 310. The first embedded AI service 314 may be operational on the AI-enabled smartphone 310. The neural circuitry 212 may be configured to reconfigure the discovered first embedded AI service 314 on the AI-enabled smartphone 310 based on the model response from the trained AI model 312. The discovered first embedded AI service 314 may be reconfigured to output user-consumable information by using the new hardware-based functionality or the new application-based functionality of the AI-enabled smartphone 310. As an example, the user consumable information may include a set of intelligent notifications associated with the first embedded AI service 314. The set of intelligent notifications may be generated or delivered on the AI-enabled smartphone 310 based on utilization of a new cloud data pre-caching functionality of the AI-enabled smartphone 310. Also, the set of intelligent notifications may indicate a “call to action” for a specific type of embedded AI service, an actionable insight as per user's preferences, or an alert message for an event or situation associated with the user 116.

FIGS. 4A and 4B, collectively, illustrate an exemplary scenario for implementation of the system of FIG. 2, in accordance with an embodiment of the disclosure. FIGS. 4A and 4B are explained in conjunction with elements from FIGS. 1, 2, and 3. With reference to FIG. 4A, there is shown a first scenario 400A. In the first scenario 400A, there is shown a smart TV 402, a remote control 404 associated with the smart TV 402, a pair of speakers 406, and a smart speaker 408. The smart speaker 408 may be communicatively coupled to the smart TV 402, via a local network 410. Additionally, the smart TV 402 may be communicatively coupled to the server 106, via the communication network 108. There is further shown a user 412 associated with the smart TV 402.

The smart TV 402 may be an AI-enabled smart TV that may correspond to the AI-enabled device 104. There is further shown a display screen 414 of the smart TV 402. The user 412 may use the remote control 404 to provide a voice input to the smart TV 402. The voice input may include a query to view present day's morning news briefing. More specifically, the voice input may correspond to an embedded AI news service on the smart TV 402.

The smart TV 402 may be configured to share the voice input with the embedded AI news service on the smart TV 402. In response to the voice input, the smart TV 402 may be configured to access and present a news briefing from one of the most watched news channel from a content delivery network (CDN). The news briefing may be presented by using the pair of speakers 406 integrated in the smart TV 402. The smart speaker 408 may not be utilized as the embedded AI news service may not be updated with the new functionality of the smart speaker 408, usage of which may have otherwise enhanced the user experience.

With reference to FIG. 4B, there is shown a second scenario 400B. The AI model on the server 106 may be configured to generate a model response that may be indicative of a functionality, such as the smart speaker 408 coupled with the smart TV 402. The neural circuitry 212 may be configured to reconfigure the embedded AI news briefing service on the smart TV 402 to use the smart speaker 408 as a preferred mode for an audio output. The smart speaker 408 may be wirelessly connected to the smart TV 402 and may be present in vicinity to the smart TV 402. In some cases, the neural circuitry 212 may be further configured to reconfigure other embedded AI services on the smart TV 402 that may need to access the smart speaker 408 to output user consumable information.

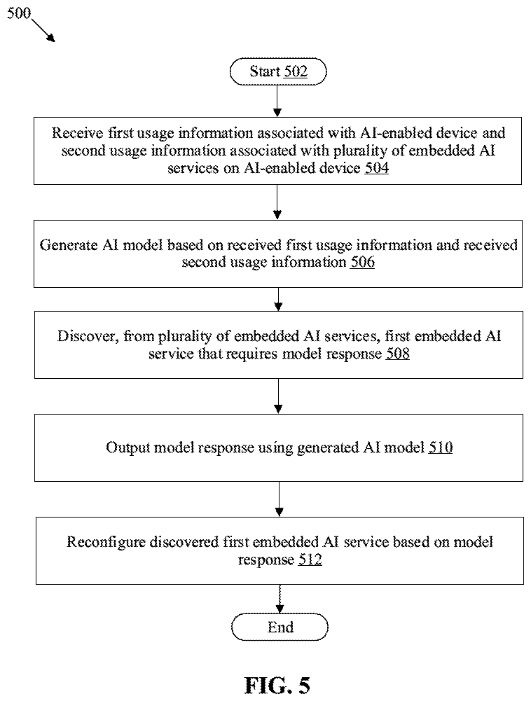

FIG. 5 depicts a flowchart that illustrates exemplary operations for reconfiguration of embedded services on devices using device functionality information configuration, in accordance with an embodiment of the disclosure. FIG. 5 is explained in conjunction with elements from FIGS. 1, 2, 3, 4A, and 4B. With reference to FIG. 5, there is shown a flowchart 500. The method, in accordance with the flowchart 500, may be implemented on the system 102. The method starts at 502 and proceeds to 504.

At 504, first usage information associated with the AI-enabled device 104 and second usage information associated with the plurality of embedded AI services 110 on the AI-enabled device 104 may be received. The neural circuitry 212 may be configured to receive the first usage information associated with the AI-enabled device 104 and the second usage information associated with the plurality of embedded AI services 110 on the AI-enabled device 104.

At 506, an AI model may be generated based on the received first usage information and the received second usage information. The AI model may be a trained ML model on the server 106. The neural circuitry 212 may be further configured to generate the AI model based on the received first usage information and the received second usage information.

At 508, a first embedded AI service that requires a model response may be discovered from the plurality of embedded AI services 110. The neural circuitry 212 may be further configured to discover, from the plurality of embedded AI services 110, the first embedded AI service that requires the model response.

At 510, the model response may be outputted using the generated AI model. The neural circuitry 212 may be configured to output the model response using the generated AI model. The model response may include first functionality information and second functionality information associated with the AI-enabled device 104. The first functionality information may include a new hardware-based functionality of the set of hardware-based functionalities of the AI-enabled device 104. Similarly, the second functionality information may include a new application-based functionality of the set of application-based functionalities of the AI-enabled device 104.

At 512, the discovered first embedded AI service may be reconfigured based on the model response. The neural circuitry 212 may be configured to reconfigure the discovered first embedded AI service based on the model response. Control passes to end.

Various embodiments of the disclosure may provide a non-transitory computer readable medium and/or storage medium, and/or a non-transitory machine readable medium and/or storage medium having stored thereon, a machine code and/or a set of instructions executable by a machine, such as the system 102, and/or a computer. The set of instructions in the system 102 may cause the machine and/or computer to perform the operations that may include a reception of first usage information associated with the AI-enabled device and second usage information associated with a plurality of embedded AI services on the AI-enabled device. The operations may further include generation of an AI model based on the received first usage information and the received second usage information. The AI model may be a trained machine learning (ML) model on the server. The operations may further include discovery, from the plurality of embedded AI services, of a first embedded AI service that requires a model response and output the model response using the generated AI model. The model response may include first functionality information and second functionality information associated with the AI-enabled device. The first functionality information may include a new hardware-based functionality of a set of hardware-based functionalities of the AI-enabled device. Similarly, the second functionality information may include a new application-based functionality of a set of application-based functionalities of the AI-enabled device. The operations may further include reconfiguration of the discovered first embedded AI service based on the model response.

Various embodiments of the present disclosure may be found in a system 102 and method for reconfiguration of embedded services on devices using device functionality information. The system 102 may include an AI-enabled device 104 and a server 106. The AI-enabled device 104 may include a plurality of embedded AI services 110 on the AI-enabled device 104. The server 106 may include neural circuitry 212. The neural circuitry 212 may be configured to receive first usage information associated with the AI-enabled device 104 and second usage information associated with the plurality of embedded AI services 110 on the AI-enabled device 104. The neural circuitry 212 may be further configured to generate an AI model based on the received first usage information and the received second usage information. The AI model may be a trained machine learning (ML) model on the server 106. The neural circuitry 212 may be further configured to discover, from the plurality of embedded AI services 110, a first embedded AI service that requires a model response and output the model response using the generated AI model. The model response may include first functionality information and second functionality information associated with the AI-enabled device 104. The first functionality information may include a new hardware-based functionality of a set of hardware-based functionalities of the AI-enabled device 104. Similarly, the second functionality information may include a new application-based functionality of a set of application-based functionalities of the AI-enabled device 104. The neural circuitry 212 may be further configured to reconfigure the discovered first embedded AI service based on the model response.

In accordance with an embodiment, the first usage information may include device activity logs, physical port usage information, and network activity information. The second usage information may include operating system (OS) activity logs, application activity logs, user activity logs, and application usage pattern information.

In accordance with an embodiment, the set of hardware-based functionalities of the AI-enabled device 104 may include an audio functionality, a video functionality, a touch screen functionality, an input/output (I/O) functionality, a gesture input functionality, a speaker functionality, a microphone functionality, and a High Definition Multimedia Interface (HDMI) functionality. The set of application-based functionalities of the AI-enabled device 104 may include a media streaming functionality, a media storage functionality, an Audio/Video (A/V) codec functionality, and a local cloud caching functionality.

In accordance with an embodiment, the neural circuitry 212 may be further configured to train an untrained AI model based on the first usage information and the second usage information associated with the AI-enabled device 104. The training of the untrained AI model may correspond to the generation of the AI model. The trained ML model may be at least one of a trained deep learning model or a Bayesian model. The neural circuitry 212 may be further configured to update the AI model based on a real time or a near-real time change in the first usage information and the second usage information of the AI-enabled device 104.

In accordance with an embodiment, the neural circuitry 212 may be further configured to determine a set of current hardware-based functionalities and a set of current application-based functionalities in use by each embedded AI service of the plurality of AI embedded services 110. The neural circuitry 212 may be further configured to discover the first embedded AI service from the plurality of AI embedded services 110 that requires a configuration setting for the new hardware-based functionality or the new application-based functionality based on the determined set of current hardware-based functionalities and the set of current application-based functionalities.

In accordance with an embodiment, the system 102 may further include a set of secondary devices, such as the secondary device 112, in a vicinity of the AI-enabled device 104. Each secondary device of the set of secondary devices may include a set of embedded AI services.

In accordance with an embodiment, the AI-enabled device 104 may include the control circuitry 206. The control circuitry 206 may be configured to generate the local network 114 between the AI-enabled device 104 and the set of secondary devices. The generated local network 114 may be at least one of a wireless home network, a wireless local area network, or a wireless ad hoc network. The neural circuitry 212 may be configured to generate a first model response that indicates availability of the local network 114 and update the plurality of embedded AI services 110 on the AI-enabled device 104 with the first model response. The control circuitry 206 may be further configured to share the model response with one or more of the plurality of secondary devices, via the local network 114. Also, in some embodiments, the neural circuitry 212 may be further configured to reconfigure, via an application programming interface (API), the set of embedded AI services on one or more of the set of secondary devices, based on the shared model response.

In accordance with an embodiment, the neural circuitry 212 may be further configured to validate the new hardware-based functionality or the new application-based functionality of the AI-enabled device 104 by application of a self-diagnostic test scheme on the first functionality information and the second functionality information. The neural circuitry 212 may be further configured to transmit the model response to the AI-enabled device 104, based on the validation of the new hardware-based functionality or the new application-based functionality. The application of the self-diagnostic test scheme on the first functionality information and the second functionality information may correspond to the validation of presence of the new hardware-based functionality or the new application-based functionality of the AI-enabled device 104.

The present disclosure may be realized in hardware, or a combination of hardware and software. The present disclosure may be realized in a centralized fashion, in at least one computer system, or in a distributed fashion, where different elements may be spread across several interconnected computer systems. A computer system or other apparatus adapted to carry out the methods described herein may be suited. A combination of hardware and software may be a general-purpose computer system with a computer program that, when loaded and executed, may control the computer system such that it carries out the methods described herein. The present disclosure may be realized in hardware that comprises a portion of an integrated circuit that also performs other functions.

The present disclosure may also be embedded in a computer program product, which comprises all the features that enable the implementation of the methods described herein, and which when loaded in a computer system is able to carry out these methods. Computer program, in the present context, means any expression, in any language, code or notation, of a set of instructions intended to cause a system that has an information processing capability to perform a particular function either directly, or after either or both of the following: a) conversion to another language, code or notation; b) reproduction in a different material form.

While the present disclosure has been described with reference to certain embodiments, it will be understood by those skilled in the art that various changes may be made and equivalents may be substituted without departure from the scope of the present disclosure. In addition, many modifications may be made to adapt a particular situation or material to the teachings of the present disclosure without departure from its scope. Therefore, it is intended that the present disclosure not be limited to the particular embodiment disclosed, but that the present disclosure will include all embodiments that falls within the scope of the appended claims.

What is claimed is:

1. A system, comprising:
an artificial intelligence (AI)-enabled device that comprises a plurality of embedded AI services on the AI-enabled device; and
a server that comprises neural circuitry, wherein the neural circuitry is configured to:
receive first usage information associated with the AI-enabled device and second usage information associated with the plurality of embedded AI services on the AI-enabled device;
generate an AI model based on the received first usage information and the received second usage information, wherein the AI model is a trained machine learning (ML) model on the server;
discover, from the plurality of embedded AI services, a first embedded AI service that requires a model response;
output the model response using the generated AI model,
wherein the model response comprises first functionality information and second functionality information associated with the AI-enabled device,
wherein the first functionality information comprises a new hardware-based functionality of a set of hardware-based functionalities of the AI-enabled device, and
wherein the second functionality information comprises a new application-based functionality of a set of application-based functionalities of the AI-enabled device; and
reconfigure the discovered first embedded AI service based on the model response.

2. The system according to claim 1, wherein the first usage information comprises device activity logs, physical port usage information, and network activity information.

3. The system according to claim 1, wherein the second usage information comprises operating system (OS) activity logs, application activity logs, user activity logs, and application usage pattern information.

4. The system according to claim 1, wherein the set of hardware-based functionalities of the AI-enabled device comprises an audio functionality, a video functionality, a touch screen functionality, an input/output (I/O) functionality, a gesture input functionality, a speaker functionality, a microphone functionality, and a High Definition Multimedia Interface (HDMI) functionality.

5. The system according to claim 1, wherein the set of application-based functionalities of the AI-enabled device comprises a media streaming functionality, a media storage functionality, an Audio/Video (A/V) codec functionality, and a local cloud caching functionality.

6. The system according to claim 1, wherein the neural circuitry is further configured to train an untrained AI model based on the first usage information and the second usage information associated with the AI-enabled device, wherein the training of the untrained AI model corresponds to the generation of the AI model.

7. The system according to claim 1, wherein the neural circuitry is further configured to update the AI model based on a real time or a near-real time change in the first usage information and the second usage information of the AI-enabled device.

8. The system according to claim 1, wherein the trained ML model is at least one of a trained deep learning model or a Bayesian model.

9. The system according to claim 1, wherein the neural circuitry is further configured to:
determine a set of current hardware-based functionalities and a set of current application-based functionalities in use by each embedded AI service of the plurality of AI embedded services; and
discover the first embedded AI service from the plurality of AI embedded services that requires a configuration setting for the new hardware-based functionality or the new application-based functionality based on the set of current hardware-based functionalities and the set of current application-based functionalities.

10. The system according to claim 1, further comprises a set of secondary devices in a vicinity of the AI-enabled device, wherein each secondary device of the set of secondary devices comprises a set of embedded AI services.

11. The system according to claim 10, further comprising control circuitry in the AI-enabled device, wherein the control circuitry is configured to generate a local network between the AI-enabled device and the set of secondary devices, and
wherein the generated local network is at least one of a wireless home network, a wireless local area network, or a wireless ad hoc network.

12. The system according to claim 11, wherein the neural circuitry is further configured to:
generate a first model response that indicates availability of the local network; and
update the plurality of embedded AI services on the AI-enabled device with the first model response that indicates the availability of the local network.

13. The system according to claim 12, wherein the control circuitry is further configured to share the model response with one or more of the plurality of secondary devices, via the local network.

14. The system according to claim 13, wherein the neural circuitry is further configured to reconfigure, via an application programming interface (API), the set of embedded AI services on one or more of the set of secondary devices, based on the shared model response.

15. The system according to claim 1, wherein the neural circuitry is further configured to validate the new hardware-based functionality or the new application-based functionality of the AI-enabled device by application of a self-diagnostic test scheme on the first functionality information and the second functionality information.

16. The system according to claim 15, wherein the neural circuitry is further configured to transmit the model response to the AI-enabled device, based on the validation of the new hardware-based functionality or the new application-based functionality.

17. The system according to claim 16, wherein the application of the self-diagnostic test scheme on the first functionality information and the second functionality information corresponds to the validation of presence of the new hardware-based functionality or the new application-based functionality of the AI-enabled device.

18. A method, comprising:
in a system that comprises neural circuitry:
receiving, by the neural circuitry, first usage information associated with the AI-enabled device and second usage information associated with a plurality of embedded AI services on the AI-enabled device;
generating, by the neural circuitry, an AI model based on the received first usage information and the received second usage information, wherein the AI model is a trained machine learning (ML) model on a server;
discovering, by the neural circuitry, from the plurality of embedded AI services, a first embedded AI service that requires a model response;
outputting, by the neural circuitry, the model response using the generated AI model,
wherein the model response comprises first functionality information and second functionality information associated with the AI-enabled device,
wherein the first functionality information comprises a new hardware-based functionality of a set of hardware-based functionalities of the AI-enabled device, and
wherein the second functionality information comprises a new application-based functionality of a set of application-based functionalities of the AI-enabled device; and
reconfiguring, by the neural circuitry, the discovered first embedded AI service based on the model response.

19. The method according to claim 18, wherein the first usage information comprises device activity logs, physical port usage information, and network activity information.

20. The method according to claim 18, wherein the second usage information comprises operating system (OS) activity logs, application activity logs, user activity logs, and application usage pattern information.
